(19) United States
(12) Patent Application Publication
(10) Pub. No.: US 2026/0194413 A1
(43) Pub. Date: Jul. 9, 2026

(54) FLUORESCENCE PRESSURE TESTING LEAKAGE DETECTION AND IDENTIFICATION DEVICE

(71) Applicant: Saudi Arabian Oil Company, Dhahran (SA)

(72) Inventors: Hadeel Al Gallaf, Saihat (SA); Ahmed Boukhamseen, Dammam (SA); Qasem A. Fandem, Qatif (SA); Mahendran Sella, Dhahran (SA)

(21) Appl. No.: 19/010,683

(22) Filed: Jan. 6, 2025

(51) Int. Cl. G01M 3/28; G01M 3/20; G01M 3/22

(52) U.S. Cl. CPC G01M 3/2815; G01M 3/207; G01M 3/22

(57) ABSTRACT

Systems and methods for fluid leak identification. Pressure data is received, from sensors attached to a heat exchanger. The heat exchanger includes tubes and a shell surrounding the tubes. A variation of the pressure data indicative of a leak in the heat exchanger is determined. A leak testing technique is selected, based on the variation of the pressure data, from a set of leak testing techniques. Each leak testing techniques defines an injection point for a fluorescent tracer and a detection target. A release the fluorescent tracer is triggered in the injection point. Images include testing data of the detection target are received. The testing data includes signals indicative of a location of the fluorescent tracer exiting through a rupture of the heat exchanger. The images are processed to identify a location of the rupture. A report including the location of the rupture of the heat exchanger is generated.

### TECHNICAL FIELD

The present disclosure is generally related to leakage detection and, more specifically, to fluorescence pressure testing for leak identification.

### BACKGROUND

Detection of fluorescence has been used to measure presence of fluids on a monitored surface, where the presence of the targeted fluids are indicative of a leakage through the monitored surface. The fluorescence signals can be detected by sensors that can be located around the perimeter of the monitored system (e.g., pipes, refinery, or storage tank). The sensors can include photodetectors that can measure in real time the fluorescence signals from fluids.

### SUMMARY

Implementations of the present disclosure are directed to leakage detection. More particularly, implementations of the present disclosure are directed to fluorescence pressure testing for leak identification.

In some implementations, a method includes: receiving, from sensors attached to a heat exchanger, pressure data including tube pressure and shell pressure, the heat exchanger including tubes and a shell surrounding the tubes, determining, by processing the pressure data, a variation of the pressure data indicative of a leak in the heat exchanger, selecting, based on the variation of the pressure data, a leak testing technique from a set of leak testing techniques, each of the set of leak testing techniques defining an injection point for a fluorescent tracer and a detection target, triggering a release the fluorescent tracer in the injection point, receiving images including testing data of the detection target, the testing data including signals indicative of a location of the fluorescent tracer exiting through a rupture of the heat exchanger, processing the images to identify a location of the rupture of the heat exchanger, and generating a report including the location of the rupture of the heat exchanger.

The foregoing and other implementations can each optionally include one or more of the following features, alone or in combination. In particular, implementations can include all the following features:

In a first aspect, combinable with any of the previous aspects, wherein the variation of the pressure data includes a decrease in the tube pressure and an identification of the shell pressure being substantially constant, wherein the leak testing technique includes a pinhole induced tube rupture detection. In another aspect, combinable with any of the previous aspects, wherein the variation of the pressure data includes a decrease in the shell pressure and an identification of the tube pressure being substantially constant, wherein the leak testing technique includes a stationery tube to tube-sheet leak detection. In another aspect, combinable with any of the previous aspects, wherein the variation of the pressure data includes a decrease in the shell pressure and an increase of the tube pressure, wherein the leak testing technique includes a floating tube to tube-sheet leak spotting using test ring. In another aspect, combinable with any of the previous aspects, wherein the variation of the pressure data includes a decrease in the tube pressure and an increase of the shell pressure, wherein the leak testing technique includes a floating head gasket leak spotting.

Other implementations of the aspect include corresponding systems, apparatus, and computer programs, configured to perform the actions of the methods, encoded on computer storage devices.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features described herein, but also include any combination of the aspects and features provided.

Implementations described in the present disclosure, provide an accurate identification of leaks in equipment configured for pressure testing, such as heat exchangers, vessels, piping, or jacketed pipe exchangers. The fluorescent particles provide an illumination contrast to help the camera sensor to identify the leakage accurately in dimly lit and restricted environments, which provides safe and efficient way of testing and inspecting functioning equipment. The described approach facilitates inspection mechanisms to ensure the reliable and continuous operation of equipment. The described inspection mechanisms include a selection of a leak testing technique, the selection being optimized based on a measurement of a tube side pressure and a shell side pressure. Another advantage of the described technology is that the described device monitors the tested system and instantaneously detect leakages location accurately. The fluorescent particles provide an illumination contrast that enhance the accurate identification of the leakage and even in dimly lit and restricted environments, which in return provides safer and more efficient way of testing and inspecting functioning equipment. Another advantage of the described technology is that the automatic activation can include triggering of automatic operations for systems and machines configured to maintain safe equipment operations.

The details of one or more implementations of the subject matter of the specification are set forth in the accompanying drawings and the description below. Other features, aspects, and advantages of the subject matter can become apparent from the description, the drawings, and the claims.

### DESCRIPTION OF THE DRAWINGS

The accompanying drawings, which are incorporated in and constitute a part of this specification, show particular aspects of the subject matter disclosed herein and, together with the description, help explain some of the principles associated with the disclosed implementations. In the drawings,

FIG. 1A is a block diagram of an example system that can be used for fluorescence pressure testing for leak identification, according to some implementations of the present disclosure.

FIG. 1B is a block diagram of a portion of the example system that can be used for fluorescence pressure testing for leak identification, according to some implementations of the present disclosure.

FIG. 2A illustrates a schematic cross-sectional side view of an example shell and

tube heat exchanger, according to some implementations of the present disclosure.

FIG. 2B illustrates a cross-sectional perspective view of a second example shell and tube heat exchanger, according to some implementations of the present disclosure.

FIG. 2C illustrates an example of a pair of test rings, according to some implementations of the present disclosure.

FIG. 3A illustrates an example of a pinhole induced tube rupture configuration, according to some implementations of the present disclosure.

FIG. 3B illustrates an example of a stationery tube to tube-sheet leak configuration, according to some implementations of the present disclosure.

FIG. 3C illustrates an example of a floating tube to tube-sheet leak spotting using test ring configuration, according to some implementations of the present disclosure.

FIG. 3D illustrates an example of a floating head gasket leak spotting with shell-cover ‘on’ configuration, according to some implementations of the present disclosure.

FIG. 3E illustrates an example of a floating head gasket leak spotting with shell-cover ‘off’ configuration, according to some implementations of the present disclosure.

FIG. 4 depicts an example of leakage spotting digital identification imagery, according to some implementations of the present disclosure.

FIG. 5A is a flowchart illustrating an example process for fluorescence pressure testing for leak identification, in accordance with some example embodiments.

FIG. 5B is a flowchart illustrating another example process for fluorescence pressure testing for leak identification, in accordance with some example embodiments.

FIG. 5C is a flowchart illustrating another example process for fluorescence pressure testing for leak identification, in accordance with some example embodiments.

FIG. 6 depicts a block diagram illustrating a computing system, in accordance with some example embodiments.

When practical, like labels are used to refer to same or similar items in the drawings.

### DETAILED DESCRIPTION

The following detailed description describes techniques for fluid leak identification. More particularly, implementations of the present disclosure are directed to fluorescence pressure testing for leak identification. The described implementations provide methods and systems for heat exchanger equipment inspection based on the detection of a variation of pressure data indicative of a leak in the heat exchanger equipment. Based on these pressure variations, an appropriate leak testing technique is selected from a set of available methods. Each method specifies an injection point for a fluorescent tracer and a detection target. The testing data includes signals that show where the fluorescent tracer exits through a rupture in the heat exchanger. The testing data is processed to generate a report indicating the location of the rupture, which can then prompt immediate remedial actions to ensure equipment safety.

Traditional methods of leak identification in heat exchanger equipment include pressure testing, soap bubble testing, dye penetrant testing, acoustic leak detection, and tracer gas leak detection. The applied traditional methods often face challenges such as difficulty in determining the exact leak location, lack of clear visuals and lighting, and maintenance inaccuracies due to plugging incorrect tubes. The described issues can lead to inefficiencies and safety risks, highlighting the importance of more advanced and reliable leak detection methods.

The techniques described in the present disclosure, address the limitations of the traditional methods of leak identification in heat exchangers, by providing a systematic and reliable leak detection technique. The described approach is based on a portable device to perform leak detection and identification with the use of fluorescent particles during the pressure testing of equipment such as heat exchangers, vessels, and other industrial components. During the hydrotest, the system can provide a live feed, on a remote user device, displaying what is happening inside the equipment without compromising the safety of operators and plant inspectors. When the processor identifies a pressure drop in the tested system, the control system can send a signal to the fluorescent pump to operate and to the fluorescent valve to open and initiate a leak test corresponding to the detected pressure drop. The sensor can detect the fluorescent particles added to the testing manifold through testing water and send a signal to the processor for the identified leakage locations. The locations of leaking pipes can be automatically marked on the initial drawing and a real-time notification to the user device. The system can generate an inspection testing report with a marked sketch to track a number of leaks found during the hydrotest. The techniques described in the present disclosure enable accurate leakage detection that can lead to accurate identification of leakage locations. Another advantage of the described techniques is the elimination of human errors and the prevention of plugging the wrong tubes. The described techniques minimize system resource consumption and maximize safe equipment operation by avoiding repeat equipment hydrotesting and decreasing equipment downtime. The described techniques enhance the maintenance process efficiency by providing a permanent testing record.

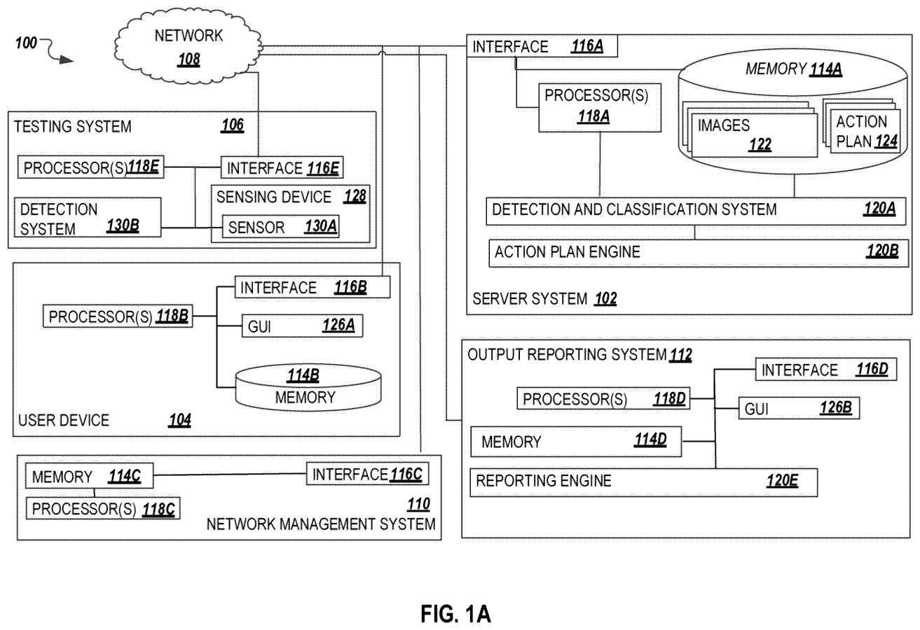

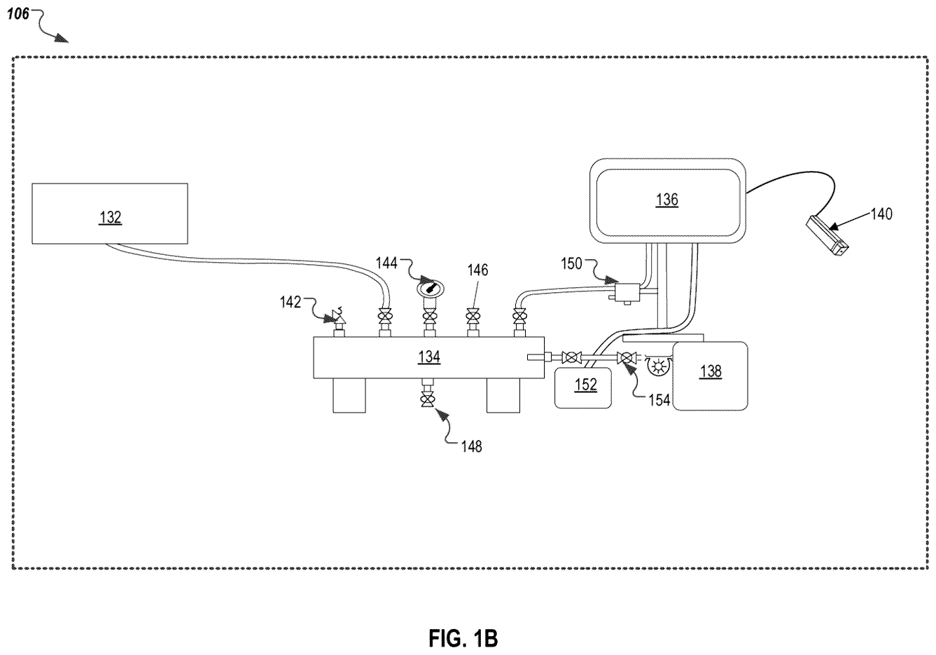

FIG. 1A is a block diagram illustrating an example system 100 that can be used for fluorescence pressure testing for leak identification, according to some implementations of the present disclosure. For example, example system 100 can be configured to execute clustering algorithms for the identification of leakage locations. The illustrated example system 100 includes or is communicably coupled with a server system 102, a user device 104, a testing system 106, a network 108, a network management system 110, and an output reporting system 112. Although shown separately, in some implementations, the functionality of two or more systems or components of the example system 100 can be provided by a single system or server. In some implementations, the functionality of one illustrated system, server, or component can be provided by multiple systems, servers, or components, respectively.

In the example of FIG. 1A, the server system 102 is intended to represent various forms of servers including, but not limited to a web server, an application server, a proxy server, a network server, and/or a server pool. In general, the server system 102 manages algorithms for unsupervised identification of leakage locations. In accordance with implementations of the present disclosure, and as noted above, the server system 102 can host a solution environment that can be a cloud environment providing software applications, systems, and services that can be consumed by customers as a service. In some implementations, the server system 102 can support configuring of various tenants of different types, as well as services of different types that are integrated in customer integration scenarios and support execution of defined processes.

For example, the server system 102 includes a memory 114A, an interface 116A, a processor 118A, and a detection and classification system 120A and an action plan engine 120B. The memory 114A can include images 122 and action plans 124. The images 122 include data measured by and received from the testing system 106. The images 122 can include images of the equipment including markers of detected by leakage locations. The images 122 can be processed by the detection and classification system 120A to generate leakage maps that are processed by the action plan engine 120B to generate action plans 124. The action plans 124 in the memory 114A can include action plan documents defining remedial operations performed by systems and machines for management of equipment, such as plugging the leaking tubes.

The user device 104, the network management system 110, and the output reporting system 112 can each be any computing device operable to connect to or communicate in the network(s) 108 using a wireline or wireless connection. In general, each of the user device 104, the network management system 110, and the output reporting system 112 includes an electronic computer device operable to receive, transmit, process, and store any appropriate data associated with the example system 100 of FIG. 1A. Each of the user device 104, the network management system 110, and the output reporting system 112 can encompass any user computing device such as a laptop/notebook computer, wireless data port, smartphone, personal data assistant (PDA), tablet computing device, one or more processors within these devices, or any other suitable processing device. The user device 104, the network management system 110, and the output reporting system 112, respectively include interface(s) 116B, 116C, 116D, processor(s) 118B, 118C, 118D, and memories 114B, 114C, 114D.

The user device 104 and the output reporting system 112, respectively, include a graphical user interface(s) (GUIs) 126A and 126B. For example, the GUIs 126A, 126B include an input device, such as a keypad, touch screen, or other device that can accept user information, and an output device that conveys information associated with the operation of the server system 102, or the user device itself, including a display of the leakage maps and action plan operations selected based on the leakage patterns. The GUIs 126A, 126B each interface with at least a portion of the example system 100 for any suitable purpose, including generating a visual representation of the images collected by the testing system 106, the leakage maps generated by the server system 102, or data stored by the server system 102, such as images 122 and action plans 124, respectively. In particular, the GUIs 126A, 126B can each be used to view and adjust various action plans. Generally, the GUIs 126A, 126B each provide the user with an efficient and user-friendly presentation of the leakage maps and action plans including leakage patterns communicated within the example system 100. The GUIs 126A, 126B can each include multiple customizable frames or views having interactive fields, for the selection of regions of interest and/or display of leakage maps for different portions of the tested equipment and testing time points. The GUIs 126A, 126B can each be any suitable graphical user interface, such as a combination of a generic web browser, intelligent engine, and command line interface (CLI) that processes information and efficiently presents the results to the user visually.

The output reporting system 112 can include a reporting engine 120C, the GUI 126B (dashboard), an interface 116D, and a processor 118D. The reporting engine 120C utilizes the analytics data provided by the action plan engine 120B to produce executive and semi executive level displays for the GUI 126B. The GUI 126B displays a high-level summary of a leak map assessment, which provides support for leakage patterns in addition to key recommended actions for equipment safety and industrial plant safety, and continuous operability. The GUI 126B display can facilitate material distribution monitoring and decision makers to modify (operations of) the systems and machines selected for repairing leaks.

The testing system 106 can include one or more sensors 130A and a detection system 130B. The sensors 130A can be pressure sensors and optionally flow meters, attached to one or more portions of the equipment, such as a shell side and a tube side of a heat exchanger. The sensors 130A can include piezoelectric pressure sensors, strain gauge pressure sensors, capacitive pressure sensors, differential pressure sensors, digital pressure gauges, or pressure transducers. The piezoelectric pressure sensors are highly sensitive (e.g., from 0.7 kPa to 70 MPa) and can measure dynamic pressure changes. The piezoelectric pressure sensors are suitable for detecting rapid pressure fluctuations in both the shell and tube sides. The strain gauge pressure sensors use a strain gauge to measure pressure changes. The strain gauge pressure sensors provide accurate pressure data, making them ideal for continuous monitoring of pressure in heat exchangers. The capacitive pressure sensors can measure pressure by detecting changes in capacitance. The capacitive pressure sensors are robust and can handle high-pressure environments, making them suitable for both the shell and tube sides. The differential pressure sensors measure the difference in pressure between two points. The differential pressure sensors can be used for monitoring the pressure drop across the heat exchanger, which can indicate fouling or blockages. The digital pressure gauges can provide real-time pressure readings and can be integrated with digital control systems for automated monitoring and control. The digital pressure gauges are versatile and can be used on both the shell and tube sides. The pressure transducers can convert pressure into an electrical signal that can be read by a digital controller. The pressure transducers can be used for integrating pressure data into a broader monitoring and control system. Using the sensors 130A the example system 100 ensures that the heat exchanger operates within safe and efficient pressure ranges, to detect potential issues early, and to maintain optimal performance. For example, the historical pressure and flow trend prior to leakage occurrence can be assessed to detect any anomaly. The identified data anomaly (e.g., deviation from the expected or historical operating patterns including sudden or gradual changes outside operational range) can be utilized to understand the type and generalized location of leakage area (shell or tube side).

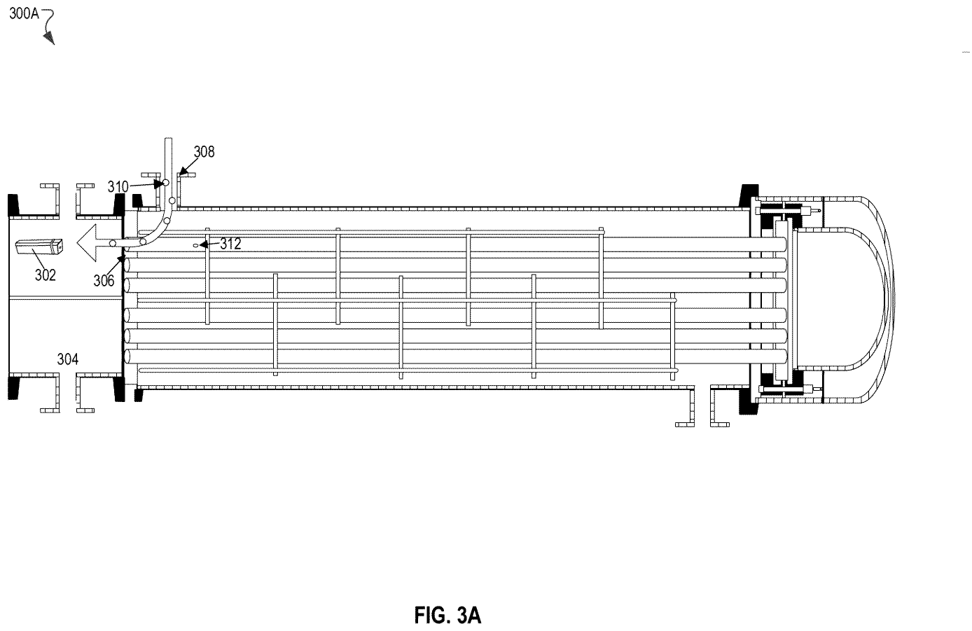

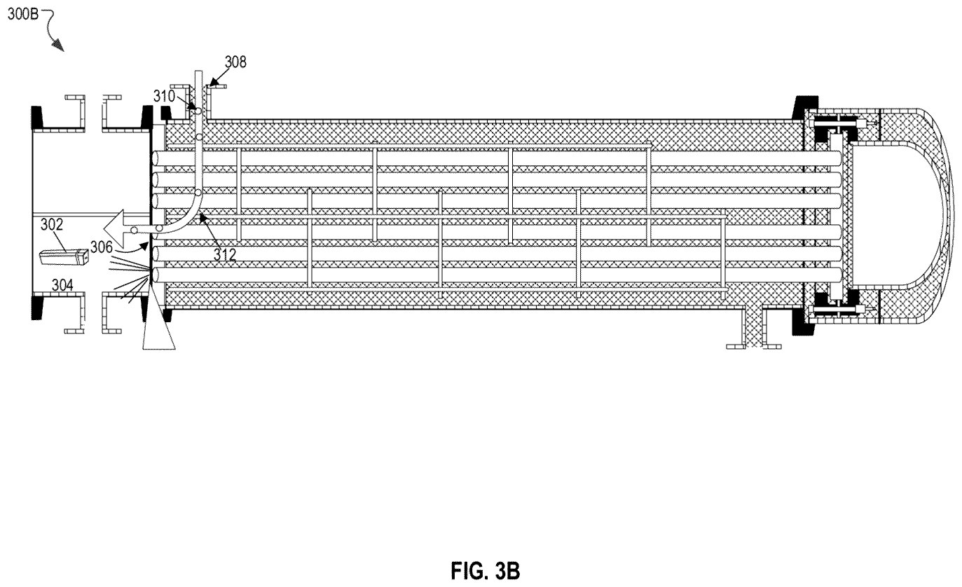

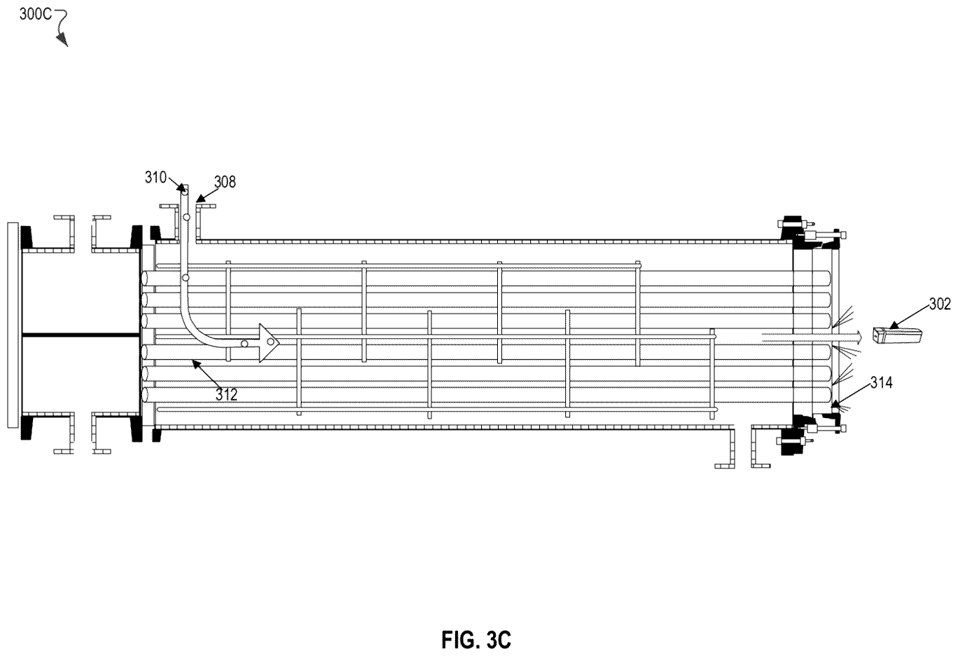

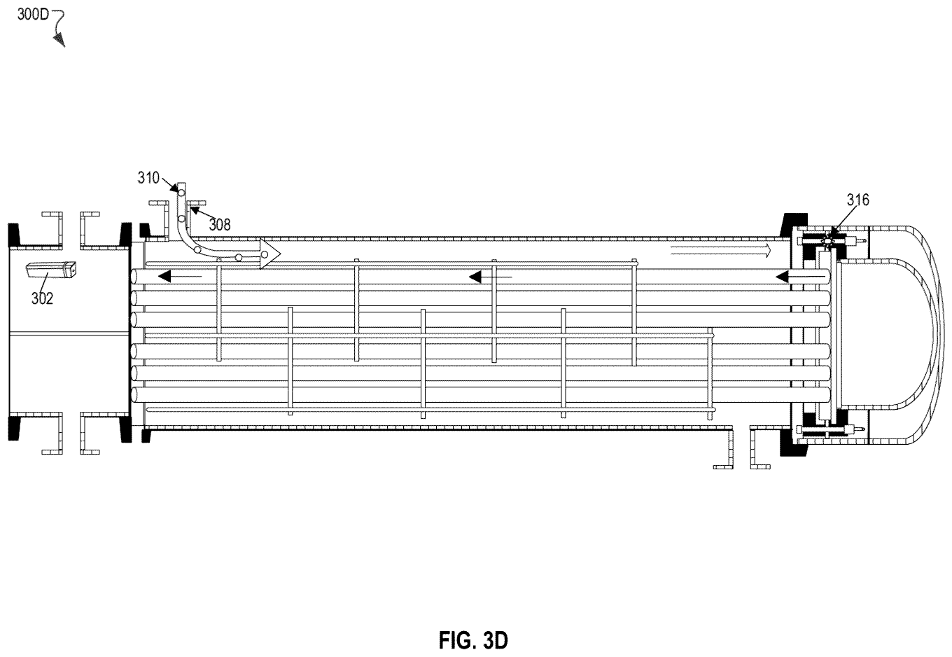

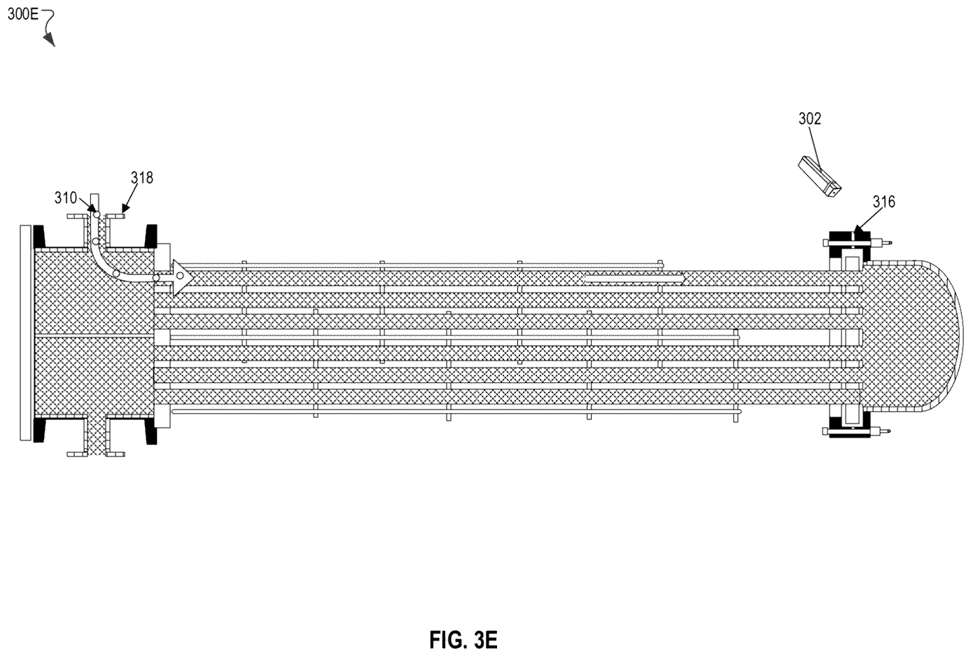

The detection system 130B can be a sensing device 128 (e.g., attached to or proximal to the tested equipment), acquiring samples and data during a testing operation. The detection system 130B can be a fluorescent detector that detects fluorescent particles added to the testing manifold through testing water and sends a signal to the processor for the identified leakage locations. The detection system 130B can include any of a scientific complementary metal-oxide-semiconductor sensor, a charge-coupled device, an electron-multiplying charge-coupled device, a photomultiplier tube, an avalanche photodiode, and other types of fluorescent particle detectors. The processor 118E of the testing system 106 controls the operation of the sensors 130A and the detection system 130B and directs collected and determined data to the server system 102 for storage, further analysis, and modeling. The sensors 130A and the detection system 130B can collect images of one or more areas of interest set by the sensing device 128. Further details about the sensors 130A and the detection system 130B and their operation are provided with reference to FIGS. 1B, and 3A-3E.

In some implementations, the network 108 can include a large computer network, such as a local area network, a wide area network, the Internet, a cellular network, a telephone network, or any appropriate combination thereof connecting any number of communication devices, mobile computing devices, fixed computing devices and server systems. Data exchanged over the network 108, is transferred using any number of network layer protocols, such as Internet Protocol, Multiprotocol Label Switching, Asynchronous Transfer Mode, Frame Relay, etc. Furthermore, in implementations where the network 108 represents a combination of multiple sub-networks, different network layer protocols are used at each of the underlying sub-networks. In some implementations, the network 108 represents one or more interconnected internetworks, such as the public Internet.

Each processor 118A, 118B, 118C, 118D, 118E included in different components of the example system 100 can include a central processing unit, an application particular integrated circuit, a field-programmable gate array, or another suitable component. Generally, each processor 118A, 118B, 118C, 118D, 118E executes instructions and manipulates data for leak classification. Each processor 118A, 118B, 118C, 118D, 118E executes a functionality required to monitor images associated to a sensing device 128, to monitor and correct leakage patterns.

Interfaces 116A, 116B, 116C, 116D, 116E are used by different components of the example system 100 for communicating with other component systems in a distributed environment—including within the example system 100—connected to the network 108. Generally, the interfaces 116A, 116B, 116C, 116D, 116E each include logic encoded in software and/or hardware in a suitable combination and operable to communicate with the network 108. More specifically, the interfaces 116A, 116B, 116C, 116D, 116E can each include software supporting one or more communication protocols associated with communications such that the network 108 or interface's hardware is operable to communicate physical signals within and outside of the illustrated system 100.

The memory 1114A, 114B, 114C, 114D can include any type of memory or database module and can take the form of volatile and/or non-volatile memory including, without limitation, magnetic media, optical media, random access memory, read-only memory, removable media, or any other suitable local or remote memory component. The memory 1114A, 114B, 114C, 114D can store various objects or data, including caches, classes, frameworks, applications, backup data, business objects, jobs, web pages, web page templates, database tables, database queries, repositories storing images 122 (e.g., images and/or dynamic information, and any other appropriate information including leakage pattern models, and any leakage remedy plans, operation instructions, safety rules, constraints, or references thereto) associated with the purposes of the server system 102, the user device 104, the testing system 106, the network management system 110, and the output reporting system 112, respectively.

There can be any number of computing devices 104 and testing systems 106 associated with, or external to, the example system 100. Additionally, there can also be one or more additional user devices external to the illustrated portion of system 100 that are configured for interacting with the example system 100 via the network(s) 108. Further, the terms “user device,” “client device,” and “user” can be used interchangeably as appropriate without departing from the scope of the disclosure. Moreover, while the user device can be described in terms of being used by a single user, the disclosure contemplates that many users can use one computer, or that one user can use multiple computers. As used in the present disclosure, the term “computer” is intended to encompass any suitable processing device. For example, although FIG. 1A illustrates a single server system 102, a single user device 104, a testing system 106, and a single network management system 110, the example system 100 can be implemented using a single, stand-alone computing device, two or more core systems 102, or multiple user device devices. The server system 102, the user device 104 and the output reporting system 112 can include any computer or processing device such as, for example, a blade server, general-purpose personal computer, workstation, or any other suitable device. In other words, the present disclosure contemplates computers other than general purpose computers, as well as computers without conventional operating systems. Further, the server system 102, and the user device 104, and the output reporting system 112 can be adapted to execute any operating system or runtime environment. According to one implementation, the server system 102 can also include or be communicably coupled with an e-mail server, a Web server, a caching server, a streaming data server, and/or another suitable server, as described with reference to FIG. 1B.

FIG. 1B is a block diagram of a portion of the example system 100 that can be for fluorescence pressure testing for leak identification, according to some implementations of the present disclosure. In particular, FIG. 1B depicts a schematic diagram illustrating an example testing system 106 of the example system 100 described with reference to FIG. 1A, in accordance with some example embodiments.

The testing system 106 includes a system to test132, a test manifold 134, a processor and digital controller 136, a fluorescent reservoir 138, a camera 140, a pressure safety valve 142, a digital pressure gauge 144, a spare for other connection146, a drain 148, a three-way valve 150, a pump 152, and a valve 154. The system to test 132 is the primary equipment or system being evaluated for leaks or performance issues. The system to test 132 can include a heat exchanger, a vessel, or a piping system. The test manifold 134 distributes the test fluid often a gas or liquid) into the system to be tested. The test manifold 134 facilitates the controlled introduction and regulation of the test medium. The processor and digital controller 136 processes data from various sensors and controls the operation of the system. The processor and digital controller 136 ensures accurate monitoring and adjustment of test parameters.

The fluorescent reservoir 138 holds the fluorescent tracer fluid used in leak detection. The fluid including fluorescent agents is injected, by a fluorescence injector, into the system to test 132. The fluorescent inlet is connected to hydrotest manifold. In case of a pressure drop during testing, the processor can activate the fluorescent pump 152 and open the valve 154 to fill in the system with fluorescent particles to detect the leak location(s) to identify leaks in one or more different locations that leaks are commonly spotted including: tube pinholes, tube-to-tube sheet joints at stationery tube-sheet, tube to tube sheet joints at floating tube-sheet, and floating head flange gasket.

The camera 140 can include a flexible high-definition telescope speak camera that can be positioned at multiple locations depending on the targeted region of interest suspected to include a rupture. The camera 140 captures images or video of the region of interest (portion of the system under test), particularly focusing on areas where the fluorescent tracer might indicate a leak. The camera 140 can be set for long exposure imaging to generate images that accurately indicate fluorescent particle detection. The camera 140 provides images including visual markers of leak locations. The pressure safety valve 142 ensures the system does not exceed safe pressure limits.

The pressure safety valve 1423 automatically releases pressure if the detected pressure exceeds a safety pressure threshold, protecting the testing system 106 from damage during testing. The digital pressure gauge 144 provides real-time pressure readings within the system. It helps monitor the pressure levels during testing to ensure they remain within safe and effective ranges. The spare for other connection 146 is an additional port that can be used for connecting other equipment or sensors as needed, providing flexibility for various testing scenarios.

The drain 148 facilitates the removal of fluids from the system after testing. The drain 148 ensures that the system to test 132 can be safely emptied and cleaned. The three-way valve 150 directs the flow of fluids within the system to test 132. The three-way valve 150 can switch between different flow paths, allowing for versatile control during testing.

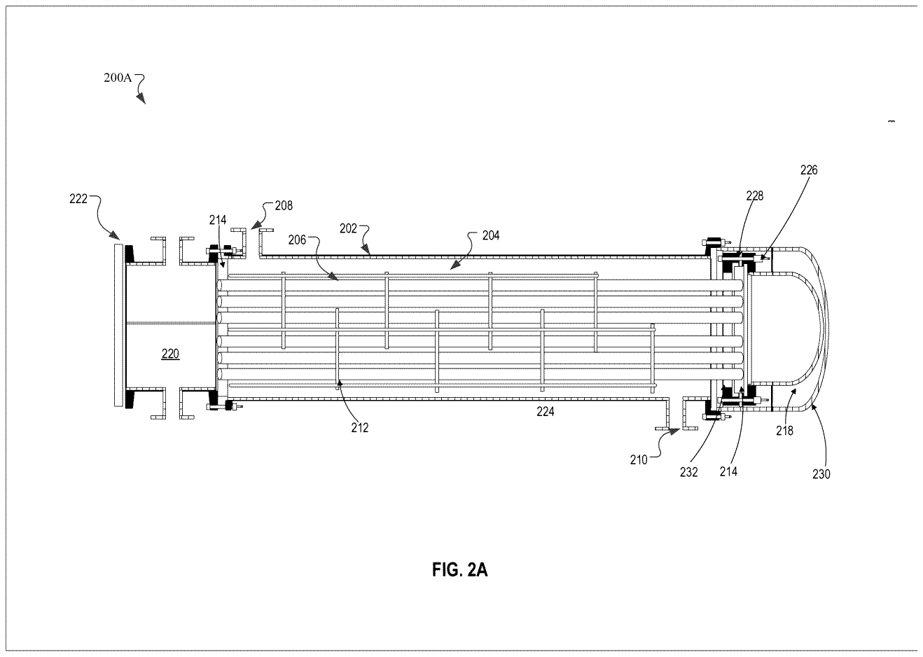

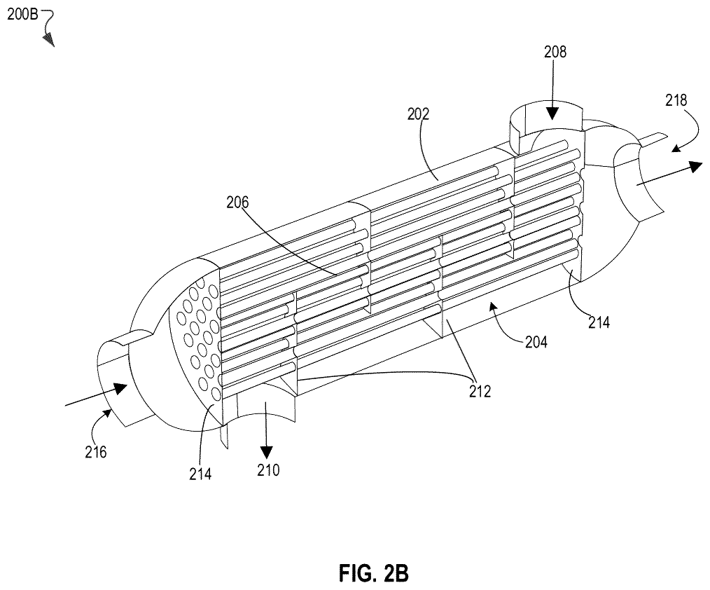

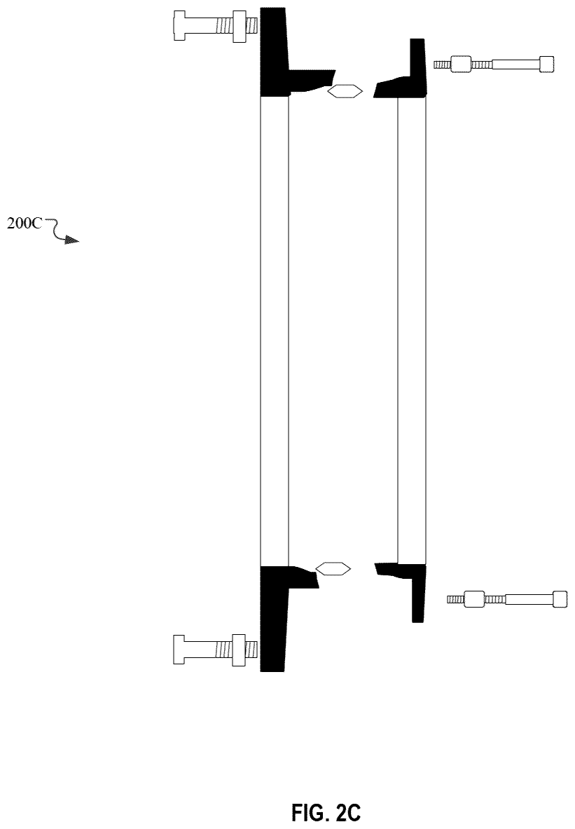

The pump 152 circulates the test fluid through the system to test 132. The pump 152 ensures that the fluorescent tracer and other test fluids are evenly distributed throughout the equipment being tested. The testing system 106 is designed to provide comprehensive and accurate leak detection and performance testing, ensuring the safety and reliability of the equipment being evaluated. The testing system 106 can be compact in size and intrinsically safe. The camera 140 and sensor 130A can be mounted on a gimbal that could be controlled remotely by a user device 104 to allow the system to easily fit maintenance holes and adjust viewing angle inside different equipment components (as described with reference to FIGS. 2A and 2B). Moreover, the device can be equipped with a charging port as well as a power source. For long piping, the camera 140 and sensor 130B can be mounted on a moving vehicle such a drone or robot to locate the exact location of the leakage. The testing system 106 can generate an inspection testing report for the leakage locations and coordinates.

FIG. 2A illustrates a schematic cross-sectional side view of an example shell and tube heat exchanger 200A, according to some implementations of the present disclosure. The example shell and tube heat exchanger 200 includes a shell 202, or housing, having an interior volume 204 arranged to support an array of tubes 206 extending through the interior volume 204. The interior volume 204 is pressure sealed between a first fluid inlet 208 and a first fluid outlet 210. The shell 202 is a cylindrical vessel that houses the tube bundle. The shell 202 is designed to withstand high pressures and temperatures. The shell 202 also includes baffles 212 to direct a first fluid through the interior volume 204 between the first fluid inlet 208 and first fluid outlet 210, for example, to promote multiple passes of the first fluid across the surfaces of the array of tubes 206.

The set of tubes 206 inside the shell 202 is called a tube bundle. The tubes 206 can be straight or bent into a U-shape. The tubes 206 are typically made from materials with good thermal conductivity and resistance to corrosion, such as stainless steel, copper alloys, or titanium. The array of tubes 206 are supported within the interior volume 204 by tube sheets 214 at opposite longitudinal ends of the interior volume 204. In some instances, the array of tubes 206 are also supported within the interior volume 204 by the baffles 212. The baffles 212 are used to direct the flow of the shell-side fluid across the tubes, enhancing heat transfer by creating turbulence.

The example shell and tube heat exchanger also includes a turbulator (not shown) disposed within each of the tubes of the array of tubes 206. A second fluid flows from a second fluid inlet 216, through the array of tubes 206, and out of a second fluid outlet 218. The second fluid flows through the array of tubes 206, and the first fluid flows over the tubes 206 and through the interior volume 204 of the shell 202 to promote heat transfer between the two fluids. The example shell and tube heat exchanger 200 is depicted as a straight-tube, two-pass shell and tube heat exchanger, though other shell and tube heat exchanger types can be implemented.

The example shell and tube heat exchanger 200 can include swirl inserts disposed along an entire length of a tube, where the swirl inserts can be twisted-tape, propeller, wavy surfaces, disconnected spiral windings, or helical coils. In some implementations, the example shell and tube heat exchanger 200 includes a cylindrical body with surface protrusions that extend radially inwardly toward a central longitudinal axis of the cylindrical body. The example turbulator is an insert that is disposed of at regular intervals inside a tube to promote continuous tripping of the boundary layer of the fluid flow through the tube. The cylindrical body is tightly fit to an interior wall of the tube, and the protrusions are arranged in a staggered array, for example, to trip an entire circumferential boundary layer of the fluid flow. In some instances, additional turbulator inserts positioned downstream of a first turbulator insert can further increase a fluid temperature gain, a larger pressure drop (such as up to 30% increase over that of a smooth pipe). The example turbulator can protect against knife-edging, such as by reducing an amount of erosion against one or more ends of the tube when the turbulator is disposed at the end(s) of the tube. Due to its configuration and function, the example shell and tube heat exchanger 200 can develop over time leakage in four different locations: tube pinholes, tube-to-tube sheet joints at stationery tube-sheet, tube to tube sheet joints at floating tube-sheet, and floating head flange gasket.

The example shell and tube heat exchanger 200 can further include a channel box 220, a channel cover 222, a shell barrel 224, floating head flange bolts 226, floating head flange gaskets 228, a shell cover 230, and a floating head split back ring 232. The channel box 220 is the section where the fluid enters the heat exchanger. It directs the fluid into the tubes for heat exchange. The channel cover 222 covers seals the channel box, ensuring that the fluid remains contained within the system and preventing leaks. The shell barrel 224 forms the main body of the heat exchanger, the shell barrel houses the tube bundle and allows the secondary fluid to flow over the tubes, facilitating heat transfer. The floating head flange bolts 226 secure the floating head in place, allowing for thermal expansion and contraction of the tubes without causing stress or damage to the heat exchanger. The floating head flange gaskets 228 provide a seal between the floating head and the shell, preventing fluid leaks and ensuring efficient operation. The shell cover 230 encloses the end of the shell barrel, providing access to the tube bundle for maintenance and inspection. The floating head split back ring 232 allows the floating head to move slightly, accommodating thermal expansion and contraction of the tubes. It helps maintain the integrity of the heat exchanger under varying temperature conditions.

FIG. 2B illustrates a cross-sectional perspective view of a second example shell and tube heat exchanger 200B, according to some implementations of the present disclosure. The second example shell and tube heat exchanger 200 is similar to the first example shell and tube heat exchanger 200 of FIG. 2A, except that the second example shell and tube heat exchanger 200 is depicted as a straight-tube, single-pass shell, and tube heat exchanger where the second fluid inlet 216 and second fluid outlet 218 are on opposite longitudinal ends of the interior volume 204, and the array of tubes 206 are meant to flow the second fluid in a single pass across the interior volume 204. Example heat exchanger systems can include the example shell and tube heat exchanger 200, the second example shell and tube heat exchanger 200, or another type of heat exchanger. In some implementations, the example shell and tube heat exchanger 200 includes a non-turbulator design. In some implementations, an example heat exchanger system includes a turbulator design, wherein the shell 202 of example shell and tube heat exchanger 200 or shell 202 of example shell and tube heat exchanger 200, one tube or several tubes extending within the interior volume of the housing, and a turbulator disposed within one or more of the tubes to agitate a flow of fluid through the tube(s). For example, multiple turbulators can be disposed within the array of tubes of a heat exchanger system such that one (or more) turbulator is positioned within each tube in the array of tubes of the shell and tube heat exchanger. In some examples, multiple turbulators are disposed within one or more of the tubes and are spaced at longitudinal intervals along a length(s) of the one or more tubes. The configuration of the tubing within the housing can vary. For example, tubing can be configured to extend parallel to a central access of the housing, perpendicular to an interior surface of the housing, or oriented in other positions within the housing. In some implementations, the array of tubes 206 are positioned within the housing to maximize surface area contact with a fluid residing in (or flowing through) the interior volume of the housing, and the array of tubes can be positioned in a variety of orientations within the housing to promote heat transfer across the surface area of the tubing.

FIG. 2C illustrates an example of a pair of test rings 200C, according to some implementations of the present disclosure. The pair of test rings 200C in a shell and tube heat exchanger plays a crucial role during hydrostatic testing by forming part of the pressure boundary. The test rings 200C are designed to hold the shell side hydro-test water within the tube bundle. The containment is essential for applying the necessary pressure to test for leaks and structural integrity. The test rings 200C facilitate pressure boundary formation by being part of the pressure boundary. The test rings 200C ensure that the pressure applied during the hydro-test is maintained within the desired sections of the heat exchanger. The test rings 200C help in accurately simulating operational conditions and identifying potential weaknesses or leaks. The test rings 200C facilitate exposure of tube sheet.

The design of the test rings 200C allows the tube sheet to be exposed to inspection personnel. The exposure can be critical for facilitating visual inspection and instrumental examination of the tube sheet for any signs of leakage or damage. The test rings 200C effectively isolate the area of interest, making it easier to detect and locate issues. The test rings 200C facilitate ease of inspection: with the tube sheet exposed, inspectors can use various detection methods, such as visual inspection, dye penetrant testing, or the use of fluorescent tracers, to identify leaks. The described setup improves the accuracy and efficiency of the inspection process. The test rings 200C facilitate the safety and reliability of leak identification by ensuring that the hydro-test water is contained, and the pressure boundary is maintained, the test rings 200C contribute to the overall safety and reliability of the heat exchanger. The test rings 200C facilitate and help prevent accidental releases of water or pressure, which could pose risks to personnel and equipment. In summary, test rings 200C are essential components that facilitate effective and accurate hydrostatic testing of shell and tube heat exchangers by containing the test water, forming a pressure boundary, and exposing the tube sheet for thorough inspection.

FIG. 3A illustrates an example of a pinhole induced tube rupture testing configuration 300A, according to some implementations of the present disclosure. The pinhole induced tube rupture testing configuration 300A is applied when sudden tube pressure loss is detected. In the pinhole induced tube rupture testing configuration 300A the channel cover is removed to place a fluorescent tracer smart detector 302 (sensor and/or a camera) within the pass partition 304. The focus of the fluorescent tracer smart detector 302 is set on the tube sheet 306. The shell side is pressurized by hydro-test. The fluorescent tracer liquid 310 is injected via shell side upper nozzle 308. As the fluorescent tracer liquid 310 gradually mixes with hydro-testing water, the fluorescent tracer passes through the pinhole 312 and flows through the stationery tube sheet 306, where it is detectable, by the fluorescent tracer smart detector 302. The fluorescent tracer detector 302 identifies the exiting tracer liquid and records its location.

FIG. 3B illustrates an example of a stationery tube to tube-sheet leak testing configuration 300B, according to some implementations of the present disclosure. The stationery tube to tube-sheet leak testing configuration 300B is applied when sudden shell side pressure loss with or without tube side pressure change. In the stationery tube to tube-sheet leak testing configuration 300B the channel cover is removed to place a fluorescent tracer smart detector 302 (sensor and/or a camera) within the pass partition 304. The focus of the fluorescent tracer smart detector 302 is set on the tube sheet 306. The shell side is pressurized by hydro-test. The fluorescent tracer liquid 310 is injected via shell side upper nozzle 308. As the fluorescent tracer liquid 310 gradually mixes with hydro-testing water and flows through the stationery tube to gaps of the tube-sheet 306, exiting the stationery tube, where it is detectable, by the fluorescent tracer smart detector 302. The fluorescent tracer detector 302 identifies the exiting tracer liquid and records its location.

FIG. 3C illustrates an example of a floating tube to tube-sheet leak spotting using test ring configuration 300C, according to some implementations of the present disclosure. The floating tube to tube-sheet leak spotting using test ring configuration 300C is applied when sudden shell side pressure loss combined with slight or marginal tube side pressure surge is detected. The shell side is pressurized by hydro-test to detect floating tube sheet leakages. The shell cover is removed along with a floating head while keeping the channel cover on. The floating tube-sheet is clamped down with the shell body flange using the pair of test rings 314. The test rings 314 enable the tube bundle to contain (hold) the shell side hydro-test water by being a part of the pressure boundary and the tube sheet is exposed for inspection. The fluorescent tracer liquid 310 is injected via shell side upper nozzle 308. The fluorescent tracer liquid 310 gradually mixes with hydro-testing water and flows through the floating tube to tube-sheet gaps. The fluorescent tracer detector 302 can detect the tracer liquid and record its location.

FIG. 3D illustrates an example of a floating head gasket leak spotting with shell-cover ‘on’ configuration 300D, according to some implementations of the present disclosure. The example floating head gasket leak spotting with shell-cover ‘on’ configuration 300D can be applied if sudden shell side pressure loss combined with gain in tube side pressure. The sudden shell side pressure loss combined with gain in tube side pressure can happen when shell side operating pressure is higher than tube side and in the event of floating head gasket bursting and the shell side fluid tends to make its way into the tube side. The channel cover is removed to expose the fixed tube sheet to the fluorescent tracer smart detector 302. The fluorescent tracer smart detector 302 is focused on the tube sheet. Pressurize shell side by hydro-test while the shell cover remains mounted and inject the fluorescent tracer liquid 310 via the shell side upper nozzle 308. Fluorescent tracer liquid 310 gradually mixes with hydro-testing water eventually makes it through the floating head 316 and makes 180 degrees U-turn inside the floating head 316, then travels back towards the stationery tube sheet via tubes. The fluorescent tracer liquid 310 can be detected at the stationery tube sheet by fluorescent tracer detector 302. The detection time duration can be 2 to 3 times longer than a typical detection time duration for a pinhole leak scenario, as described with reference to FIG. 3A. The leakage can be spotted via multiple tubes with very diluted tracer liquid concentrations. The fluorescent tracer detector 302 can detect the tracer liquid 310 and record the tracer liquids 310 from multiple tubes.

FIG. 3E illustrates an example of a floating head gasket leak spotting with shell-cover ‘off’ configuration 300E, according to some implementations of the present disclosure. The example of a floating head gasket leak spotting with shell-cover ‘off’ configuration 300E is applied after sudden tube pressure loss combined with gain in shell side pressure is detected. The sudden tube pressure loss combined with gain in shell side pressure can happen when tube side operating pressure is higher than shell side and in the event of a floating head gasket bursting, the tube side fluid tends to make its way into the shell side. The channel cover is removed to expose the fixed tube sheet to the fluorescent tracer smart detector 302. The tube-side is pressurized by the hydro-test. To increase visibility the shell cover is removed. The fluorescent tracer liquid 310 is injected via shell side upper nozzle 318. The fluorescent tracer liquid flows through the floating head gasket at the other end of the tube bundle due to the shorter path. The time taken for getting detected can be slightly longer than a typical pinhole leak scenario, as described with reference to FIG. 3A. The leakage can be spotted via a floating gasket accurately. The fluorescent tracer detector 302 can promptly detect the tracer liquid 310 and record the location of the tracer liquid concentration zones.

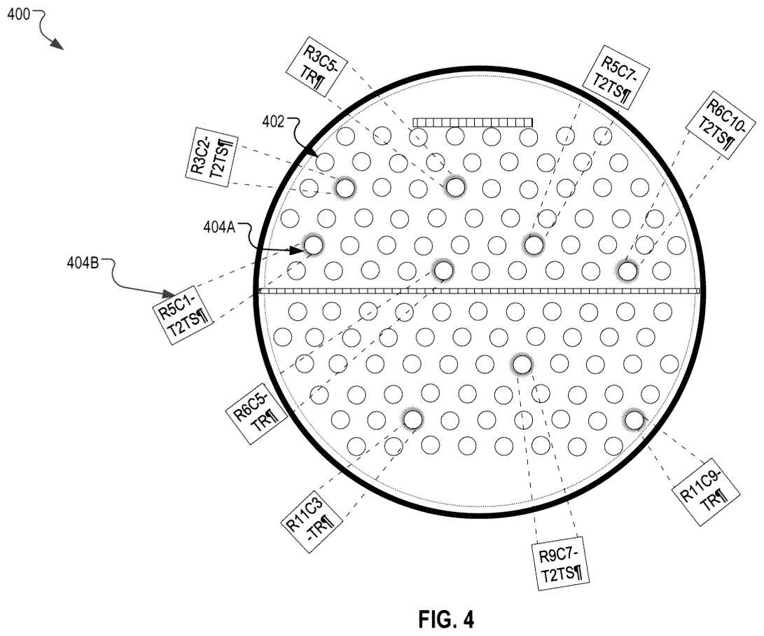

FIG. 4 depicts an example of leakage spotting digital identification image 400, according to some implementations of the present disclosure, as shown in Table 1. The example of leakage spotting digital identification image 400 can be generated by a fluorescent tracer detector 302 using a leakage detection configuration, as described with reference to any of FIGS. 3A-3D. The example of leakage spotting digital identification image 400 can include a representation of the distribution of the tubes 402 according to a set arrangement along rows and columns. The tubes where tracer liquid is recorded can be marked by highlighters 404A and other identifiers 404B.

TABLE 1

| | FAILURE LOCATION | |
|---|---|---|
| S. # | ROW/COLUMN | TYPE OF FAILURE |
| 1 | 3^{rd} Row 5^{th} Tube | TUBE RUPTURE |
| 2 | 5^{th} Row 7^{th} Tube | TUBE-TUBE SHEET LEAK |
| 3 | 6^{th} Row 10^{th} Tube | TUBE-TUBE SHEET LEAK |
| 4 | 11^{th} Row 9^{th} Tube | TUBE RUPTURE |
| 5 | 9^{th} Row 7^{th} Tube | TUBE-TUBE SHEET LEAK |
| 6 | 11^{th} Row 3^{rd} Tube | TUBE RUPTURE |
| 7 | 6^{th} Row 5^{th} Tube | TUBE RUPTURE |
| 8 | 5^{th} Row 1^{st} Tube | TUBE-TUBE SHEET LEAK |
| 9 | 3^{rd} Row 2^{nd} Tube | TUBE-TUBE SHEET LEAK |

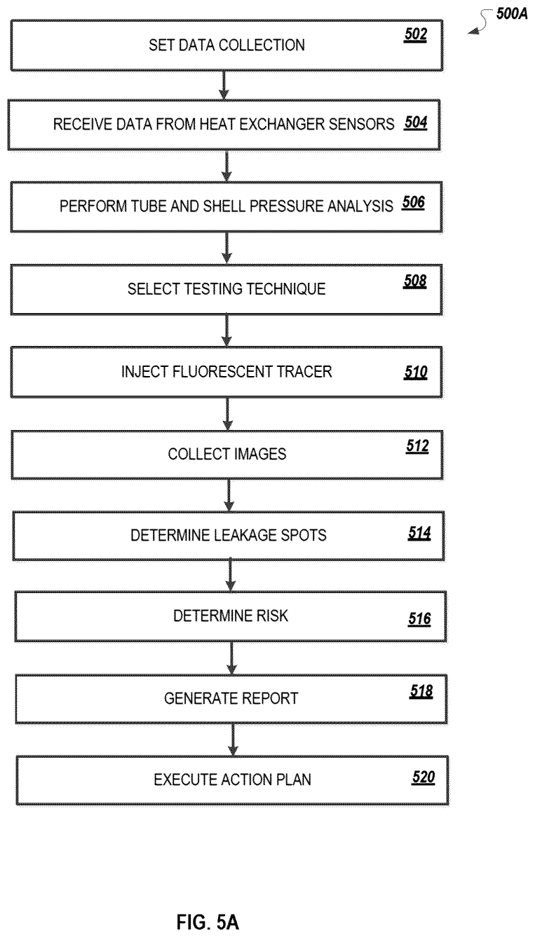

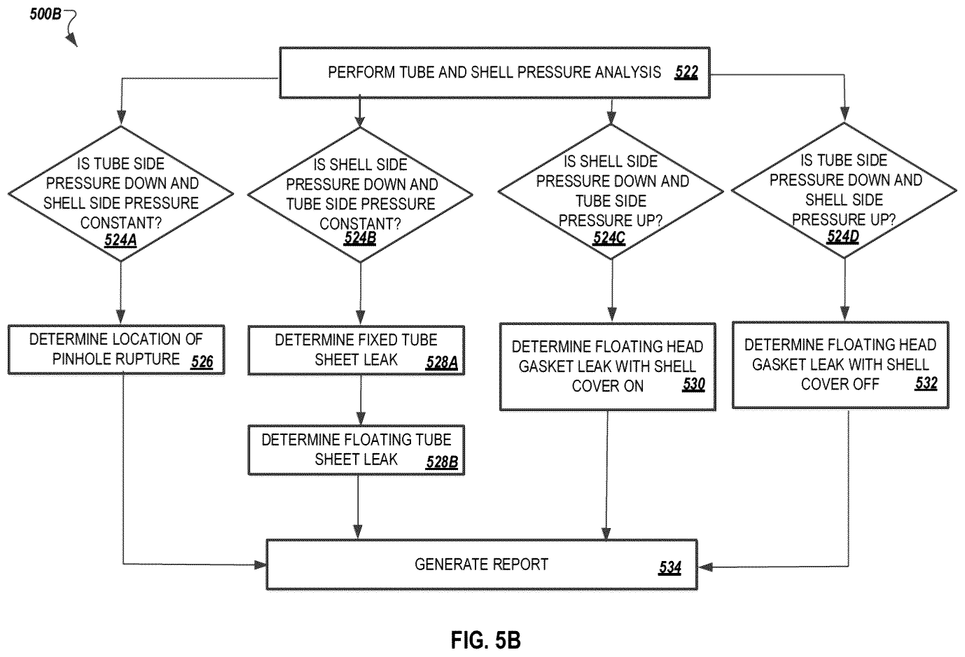

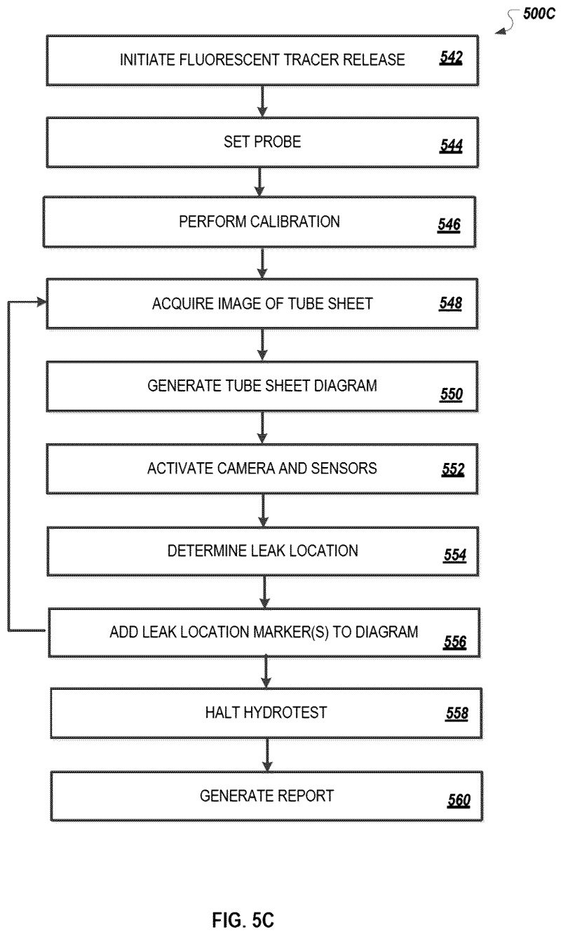

FIG. 5A depicts a flowchart illustrating an example process 500A for leak identification, in accordance with some example embodiments. Referring to FIGS. 1-3, the process 500A can be performed by any components of the example systems 100, 200, 300.

At 502, data collection for equipment inspection including leak identification is set, by one or more processors. The equipment can include a heat exchanger and one or more pipes or tubes.

At 504, data is received, by the one or more processors, from sensors monitoring one or more parameters of a heat exchanger and one or more pipes or tubes. The parameters include pressure data and, optionally, flow rate signals. For example, the parameters include tube pressure and shell pressure currently recorded. The parameters recorded over a set time interval (e.g., minimum 8 weeks before a failure occurred) can be retrieved from a database (e.g., memory 114A, 114B, described with reference to FIG. 1A).

At 506, tube pressure and shell pressure analysis are performed, by the one or more processors to determine a variation of a trend of the pressure data indicative of a leak in the heat exchanger. To determine a variation of a trend of the pressure data one or more filtering techniques can be applied to remove outliers. The analysis of the variation of the pressure data can lead to a differentiation between a constant and a decreased tube side pressure and between a constant and a decreased shell pressure. The analysis of the variation of the pressure data can indicate which side pressure drop triggered, what is the rate of drop/spike, what is the corresponding coincidental signals from other instruments that could have caused pressure loss/spike, etc.

At 508, a testing technique is selected, by the one or more processors, from a set of leak testing techniques. Each of the set of leak testing techniques defines an injection point for a fluorescent tracer and a detection target. The leak testing technique can include a pinhole induced tube rupture detection or a stationery tube to tube-sheet leak detection or a floating tube to tube-sheet leak spotting using a test ring or a floating head gasket leak spotting.

At 510, a fluorescent tracer is injected into a portion (e.g., nozzle) of the equipment as defined by the selected testing technique, as described in detail with reference to FIGS. 3A-3D. Different types of fluorescent tracers can be used for injection. In some implementations, the fluorescent tracer can include water-based dyes for water systems, oil-based dyes for hydraulic and lubrication systems, and universal dyes that can be used in multiple types of fluids. Injecting the fluorescent tracer in the equipment includes opening an entry point of the equipment, coupling a tube connected to a fluorescent reservoir to the entry point, and starting a pump to inject the fluorescent tracer (mixed with water) into a portion of the equipment to generate a flow along a set pathway.

At 512, images are collected, by one or more cameras and one or more fluorescent tracer detectors, in response to an imaging trigger generated by the one or more processors. In some implementations, multiple cameras and fluorescent tracer detectors can be connected to be focused on the targeted portion of the equipment from different angles. The imaging setup can be temporary and can be automatically dismantled after the test is completed. The camera can be mounted on a tripod and can be moved around anywhere around the heat exchanger under investigation. Images collected by the fluorescent tracer detector can have several distinct characteristics that enhance their utility in leak detection. For example, the images can have a high contrast. Fluorescent tracers emit light at specific wavelengths when exposed to ultraviolet light or other excitation light sources that create a high contrast between the tracer and the surrounding environment, making leaks or other areas of interest easily identifiable. The resolution of the images depends on the quality of the camera sensor used. High-resolution sensors can capture fine details, which is crucial for accurately pinpointing the location of leaks. The images can be acquired in real-time using long exposure camera settings, while the detector is fixed in position. The fluorescent tracer detector can provide real-time imaging capabilities, facilitating immediate identification and assessment of leaks. Depending on the design of the imaging system, images can be captured at a wide field of view, enabling the inspection of large areas without the need for multiple images.

At 514, leakage spots are determined, the data package is processed, by the one or more processors. Processing the data package can include processing the images using a processing tool selected based on a set resolution of the sensing images. The image preprocessing can include image alignment and quantification. The intensity of the fluorescence can be quantified, providing data on the concentration of the tracer and the size of the leak. The concentration of the tracer and the size of the leak are used for assessing the severity of leaks that can be ranked for prioritizing planned repairs:

At 516, a risk of the equipment is determined, by the one or more processors, based on the severity of leaks. The identified leaks can be classified, by an artificial intelligence model trained to analyze the images. The images can be processed using an artificial intelligence model to determine a leak pattern for the inspected equipment. The identification of leak patterns can include the characterization of the equipment damage and prediction of damage progression. The artificial intelligence model can include a machine learning (ML) model or a deep learning (DL) model. The ML model can include supervised learning ML model or an unsupervised learning ML model. The supervised learning ML model uses labeled data to train models to recognize patterns in damage progression. Common algorithms include decision trees, support vector machines, and neural networks. The unsupervised learning ML model identifies patterns in data without predefined labels using techniques like clustering (e.g., K-means) and dimensionality reduction (e.g., PCA). The DL model can include convolutional neural networks (CNNs) or a generative model. The CNN model can analyze spatial patterns in images, such as leak patterns that can be affected by equipment operations. The artificial intelligence model can be trained using historical data or synthetically generated data along with techniques comprising transfer-learning, multi-task learning, continual learning, supervised learning, unsupervised learning, or domain adaptation. The artificial intelligence model can quantify the leak risk based on a comparison of the quantified fluorescent tracer distribution change within a suspect region to a change threshold to determine whether the quantified change is greater or smaller than the change threshold. The change threshold can be a set value derived from historical fluorescent tracer distribution changes within a labeled image that was significantly correlated with equipment safety risks.

At 518, a report is generated, by the one or more processors. The report can be displayed in real time, by a user device. The leak report for a heat exchanger can include several key elements to provide a comprehensive overview of the inspection and findings. The leak report can include identification information, such as details about the specific heat exchanger, including its model, serial number, and location within the facility. The leak report can include the inspection date and conducted testing technique. For example, a description of the methods used for leak detection, such as hydrostatic testing, dye penetrant testing, or the use of fluorescent tracers can be listed. The leak report can include pressure data, such as recorded pressure levels during the test, including any variations that indicate potential leaks. The leak report can include leak locations, such as detailed information on the exact locations of any detected leaks, often accompanied by images or diagrams. The leak identification section can include the specific tubes or areas within the heat exchanger where leaks were found. The leak report can include a severity assessment as an evaluation of the severity of each leak, which helps prioritize repairs. The leak report can include the size of the leak and its potential impact on the system's performance and safety. The leak report can include visual evidence, such as photographs or video footage captured during the inspection, particularly highlighting areas where leaks were detected. Fluorescent tracer images can be included to show the precise leak points. The leak report can include recommendations for repairing the detected leaks, including any immediate remedial actions required to maintain safety and operational efficiency.

At 520, an action plan is determined and executed, by the one or more processors. An action plan defines one or more remedial actions and any additional steps to be taken after the initial repairs, such as re-testing or further inspections to ensure the integrity of the repairs. A corresponding surface equipment can be identified by machine learning models (e.g., recurrent neural networks with a multi-layer network topology) trained and fine-tuned to generate an automatic selection of an efficient remedial action (e.g., activation of one or more machines configured to seal leaks). The trained machine learning models can be configured to operate in active mode, for equipment protection, facilitating automatic action plan implementation. For example, the trained machine learning models can trigger an initiation of the action plan, and a modification of machine operations based on leak locations relative to the equipment configuration and availability of additional remedial actions to facilitate equipment and facility safety. The action plan is automatically executed by generating a trigger, by the one or more processors, to activate an operation of a system or a machine configured to perform a remedy operation.

FIG. 5B depicts a flowchart illustrating an example process 500B for leak identification, in accordance with some example embodiments. Referring to FIGS. 1-3, the process 500B can be performed by any components of the example systems 100, 200, 300.

At 522, tube and shell pressure analysis are performed by monitoring pressure data received from sensors attached to tubes and shells of the heat exchanger. The sensors are attached to multiple portions of the of the heat exchanger to enable the detection of multi-source leakages.

At 524A, it is determined whether tube side pressure is down and whether shell side pressure is substantially constant (with less than 5% variations from a median value). At 524B, it is determined whether shell side pressure is down and whether tube side pressure is constant. At 524C, it is determined whether shell side pressure down and tube side pressure is up. At 524D, it is determined whether tube side pressure is down and whether shell side pressure is up.

At 526, in response to determining that the tube side pressure is down and whether shell side pressure is constant, a location of a pinhole rupture is determined.

At 528A, in response to determining that the shell side pressure is down and whether tube side pressure is constant, a fixed tube sheet leak is determined. At 528B, a floating tube sheet leak is determined.

At 530, in response to determining that the shell side pressure down and tube side pressure is up, a floating head gasket leak is determined with a shell cover on.

At 532, in response to determining that the tube side pressure is down and whether shell side pressure is up, a floating head gasket leak is determined with the shell cover off.

At 534, a report is generated, by the one or more processors.

FIG. 5C depicts a flowchart illustrating an example process 500C for leak identification, in accordance with some example embodiments. Referring to FIGS. 1-3, the process 500C can be performed by any components of the example systems 100, 200, 300.

At 542, a fluorescent tracer release is initiated. For example, a particular quantity of fluorescent tracer can be mixed with an unknown quantity of water stored in a fluid reservoir, from where the fluid is being pumped through a fluid flow path of an equipment.

At 544, one or more sensors are set to monitor pressure at different components of the equipment. The sensors can include pressure sensors, as described with reference to FIG. 1A.

At 546, a calibration is performed. For example, power supply, a detection angle, a detection focus, and field of view are set, tested, and optimized to increase the accuracy of the leak identification using the calibrated detector.

At 548, an image of a tube sheet is acquired, using one or more cameras.

At 550, a tube sheet diagram is generated from the image of the tube sheet.

At 552, cameras and sensors are activated to identify leaks within the system.

At 554, a leak location is determined relative to the tube sheet diagram.

At 556, the leak location markers are added to the tube sheet diagram. The leak location markers can include position information and fluorescent tracer concentration identification.

At 558, in response to determining that the leak location and quantification are completed, the hydrotest is paused or stopped.

At 560, a report is generated to be displayed by a user device. The report can include the hydro test details and significant leaks. The report can be formatted twain Claude the tube sheet diagram and the leak location markers, as described with reference to FIG. 4.

The example processes 500A, 500B, 500C facilitate the optimization of accurate identification of locations of ruptures of a heat exchanger and the generation of an action plan using Images acquired and processed in real-time. The fluorescent tracer detector can provide real-time imaging capabilities, allowing for immediate identification and assessment of leaks. The example processes 500A, 500B, 500C are particularly useful in dynamic testing environments. Fluorescent imaging can be effective in a range of lighting conditions, including dimly lit portions of equipment, due to the strong signal emitted by the fluorescent tracer. The fluorescent tracer characteristics make fluorescent tracer detectors a powerful tool for leak detection, providing clear, accurate, and actionable images. The images can have a high sensitivity even to small amounts of fluorescent tracer, facilitating the detection of minor leaks that might be missed by other methods. One of the greatest benefits of fluorescent imaging for the generation of an accurate exposed leakage map is that it optimizes resources dedicated to data processing while increasing safe equipment operation. The example processes 500A, 500B, 500C provide an activation of automatic remedial machine actions to ensure safe equipment operations. The example processes 500A, 500B, 500C also provide resource conservation opportunities by minimizing computing system requirements and optimization of identification of leaks in heat exchangers.

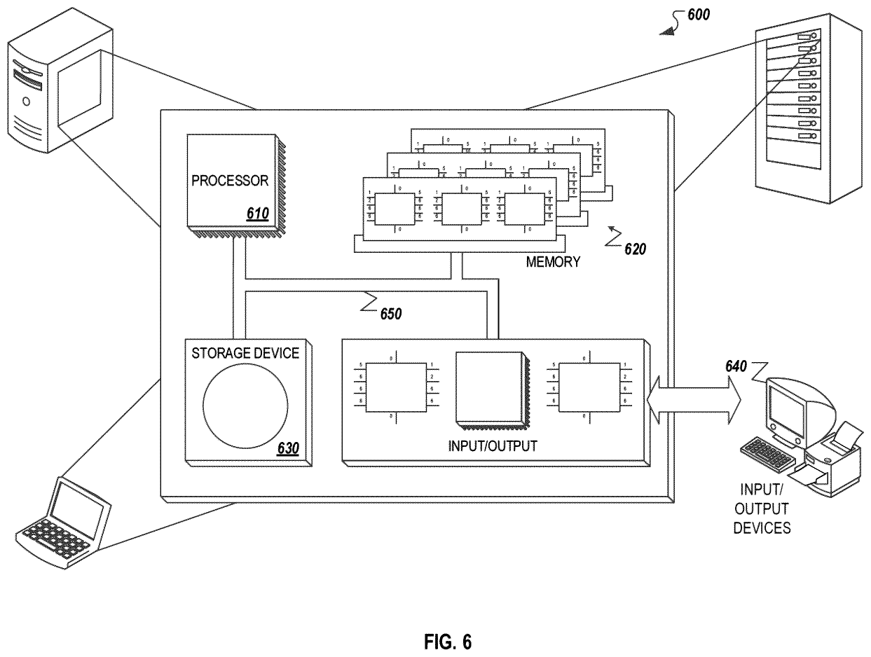

FIG. 6 depicts a block diagram illustrating a computing system 600, in accordance with some example embodiments. Referring to FIGS. 1A and 1B, the computing system 600 can be used to implement the server system 102 and/or any other components of the example system 100.

As shown in FIG. 6, the computing system 600 can include a processor 610, a memory 620, a storage device 630, and input/output devices 640. The processor 610, the memory 620, the storage device 630, and the input/output devices 640 can be interconnected using a system bus 650. The processor 610 is capable of processing instructions for execution within the computing system 600. Such executed instructions can implement one or more components of, for example, the example system 100. In some implementations of the current subject matter, the processor 610 can be a single-threaded processor. Alternately, the processor 610 can be a multi-threaded processor. The processor 610 is capable of processing instructions stored in the memory 620 and/or on the storage device 630 to display graphical information for a user interface provided using the input/output device 640.

The memory 620 is a computer readable medium such as volatile or non-volatile that stores information within the computing system 600. The memory 620 can store data structures representing configuration object databases, for example. The storage device 630 can provide persistent storage for the computing system 600. The storage device 630 can be a floppy disk device, a hard disk device, an optical disk device, a tape device, or other suitable persistent storage means. The input/output device 640 provides input/output operations for the computing system 600. In some implementations of the current subject matter, the input/output device 640 includes a keyboard and/or pointing device. In various implementations, the input/output device 640 includes a display unit for displaying graphical user interfaces.

According to some implementations of the current subject matter, the input/output device 640 can provide input/output operations for a network device. For example, the input/output device 640 can include Ethernet ports or other networking ports to communicate with one or more wired and/or wireless networks (e.g., a local area network (LAN), a wide area network (WAN), the Internet).

In some implementations of the current subject matter, the computing system 600 can be used to execute various interactive computer software applications that can be used for organization, analysis and/or storage of data in various (e.g., tabular) format (e.g., Microsoft Excel®, and/or any other type of software). Alternatively, the computing system 600 can be used to execute any type of software applications. These applications can be used to perform various functionalities, e.g., planning functionalities (e.g., generating, managing, editing of spreadsheet documents, word processing documents, and/or any other objects), computing functionalities, or communications functionalities. The applications can include various add-in functionalities or can be standalone computing products and/or functionalities. Upon activation within the applications, the functionalities can be used to generate the user interface provided using the input/output device 640. The user interface can be generated and presented to a user by the computing system 600 (e.g., on a computer screen monitor).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include user devices and servers. A user device and server system are remote from each other and typically interact through a communication network. The relationship of user device and server arises by virtue of computer programs running on the respective computers and having a user device-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input. Other input devices include touch screens or other touch-sensitive devices such as single or multi-point resistive or capacitive track pads, voice recognition hardware and software, optical scanners, optical pointers, digital image capture devices, and associated interpretation software, and the like.

The preceding figures and accompanying description illustrate example processes and computer implementable techniques. The environments and systems described above (or their software or other components) can contemplate using, implementing, or executing any suitable technique for performing these and other tasks. It can be understood that these processes are for illustration purposes only and that the described or similar techniques can be performed at any appropriate time, including concurrently, individually, in parallel, and/or in combination. In addition, many of the operations in these processes can take place simultaneously, concurrently, in parallel, and/or in different orders than as shown. Moreover, processes can have additional operations, fewer operations, and/or different operations, so long as the methods remain appropriate.

In other words, although the disclosure has been described in terms of certain implementations and generally associated methods, alterations and permutations of these implementations, and methods will be apparent to those skilled in the art. Accordingly, the above description of example implementations does not define or constrain the disclosure. Other changes, substitutions, and alterations are also possible without departing from the spirit and scope of the disclosure.

A number of implementations of the present disclosure have been described. Nevertheless, it will be understood that various modifications can be made without departing from the spirit and scope of the present disclosure. Accordingly, other implementations are within the scope of the following claims.

In view of the above-described implementations of the subject matter, this application discloses the following list of examples, wherein one feature of an example in isolation or more than one feature of said example taken in combination and, optionally, in combination with one or more features of one or more further examples are further examples also falling within the disclosure of this application.

Example 1. A computer-implemented method comprising: receiving, from sensors attached to a heat exchanger, pressure data comprising tube pressure and shell pressure, the heat exchanger comprising tubes and a shell surrounding the tubes; determining, by processing the pressure data, a variation of the pressure data indicative of a leak in the heat exchanger; selecting, based on the variation of the pressure data, a leak testing technique from a set of leak testing techniques, each of the set of leak testing techniques defining an injection point for a fluorescent tracer and a detection target; triggering a release the fluorescent tracer in the injection point; receiving images comprising testing data of the detection target, the testing data comprising signals indicative of a location of the fluorescent tracer exiting through a rupture of the heat exchanger; processing the images to identify a location of the rupture of the heat exchanger; and generating a report comprising the location of the rupture of the heat exchanger.

Example 2. The computer-implemented method of the previous example, wherein the variation of the pressure data comprises a decrease in the tube pressure and an identification of the shell pressure being substantially constant.

Example 3. The computer-implemented method of any of the previous examples, wherein the leak testing technique comprises a pinhole induced tube rupture detection.

Example 4. The computer-implemented method of any of the previous examples, wherein the variation of the pressure data comprises a decrease in the shell pressure and an identification of the tube pressure being substantially constant.

Example 5. The computer-implemented method of any of the previous examples, wherein the leak testing technique comprises a stationery tube to tube-sheet leak detection.

Example 6. The computer-implemented method of any of the previous examples, wherein the variation of the pressure data comprises a decrease in the shell pressure and an increase of the tube pressure.

Example 7. The computer-implemented method of any of the previous examples, wherein the leak testing technique comprises a floating tube to tube-sheet leak spotting using test ring.

Example 8. The computer-implemented method of any of the previous examples, wherein the variation of the pressure data comprises a decrease in the tube pressure and an increase of the shell pressure.

Example 9. The computer-implemented method of any of the previous examples, wherein the leak testing technique comprises a floating head gasket leak spotting.

Example 10. A computer-implemented system comprising: memory storing application programming interface (API) information; and a server performing operations comprising: receiving, from sensors attached to a heat exchanger, pressure data comprising tube pressure and shell pressure, the heat exchanger comprising tubes and a shell surrounding the tubes; determining, by processing the pressure data, a variation of the pressure data indicative of a leak in the heat exchanger; selecting, based on the variation of the pressure data, a leak testing technique from a set of leak testing techniques, each of the set of leak testing techniques defining an injection point for a fluorescent tracer and a detection target; triggering a release the fluorescent tracer in the injection point; receiving images comprising testing data of the detection target, the testing data comprising signals indicative of a location of the fluorescent tracer exiting through a rupture of the heat exchanger; processing the images to identify a location of the rupture of the heat exchanger; and generating a report comprising the location of the rupture of the heat exchanger.

Example 11. The computer-implemented system of the previous example, wherein the variation of the pressure data comprises a decrease in the tube pressure and an identification of the shell pressure being substantially constant.

Example 12. The computer-implemented system of any of the previous examples, wherein the leak testing technique comprises a pinhole induced tube rupture detection.

Example 13. The computer-implemented system of any of the previous examples, wherein the variation of the pressure data comprises a decrease in the shell pressure and an identification of the tube pressure being substantially constant.

Example 14. The computer-implemented system of any of the previous examples, wherein the leak testing technique comprises a stationery tube to tube-sheet leak detection.

Example 15. The computer-implemented system of any of the previous examples, wherein the variation of the pressure data comprises a decrease in the shell pressure and an increase of the tube pressure.

Example 16. The computer-implemented system of any of the previous examples, wherein the leak testing technique comprises a floating tube to tube-sheet leak spotting using test ring.

Example 17. The computer-implemented system of any of the previous examples, wherein the variation of the pressure data comprises a decrease in the tube pressure and an increase of the shell pressure.

Example 18. The computer-implemented system of any of the previous examples, wherein the leak testing technique comprises a floating head gasket leak spotting.

Example 19. A non-transitory computer-readable media encoded with a computer program, the computer program comprising instructions that when executed by one or more computers cause the one or more computers to perform operations comprising: receiving, from sensors attached to a heat exchanger, pressure data comprising tube pressure and shell pressure, the heat exchanger comprising tubes and a shell surrounding the tubes; determining, by processing the pressure data, a variation of the pressure data indicative of a leak in the heat exchanger; selecting, based on the variation of the pressure data, a leak testing technique from a set of leak testing techniques, each of the set of leak testing techniques defining an injection point for a fluorescent tracer and a detection target; triggering a release the fluorescent tracer in the injection point; receiving images comprising testing data of the detection target, the testing data comprising signals indicative of a location of the fluorescent tracer exiting through a rupture of the heat exchanger; processing the images to identify a location of the rupture of the heat exchanger; and generating a report comprising the location of the rupture of the heat exchanger.

Example 20. The non-transitory computer-readable media of the previous example, wherein the variation of the pressure data comprises a decrease in the tube pressure and an identification of the shell pressure being substantially constant, wherein the leak testing technique comprises a pinhole induced tube rupture detection or wherein the variation of the pressure data comprises a decrease in the shell pressure and an identification of the tube pressure being substantially constant, wherein the leak testing technique comprises a stationery tube to tube-sheet leak detection or wherein the variation of the pressure data comprises a decrease in the shell pressure and an increase of the tube pressure, wherein the leak testing technique comprises a floating tube to tube-sheet leak spotting using test ring or wherein the variation of the pressure data comprises a decrease in the tube pressure and an increase of the shell pressure, wherein the leak testing technique comprises a floating head gasket leak spotting.

What is claimed is:

1. A computer-implemented method comprising:
receiving, from sensors attached to a heat exchanger, pressure data comprising tube pressure and shell pressure, the heat exchanger comprising tubes and a shell surrounding the tubes;
determining, by processing the pressure data, a variation of the pressure data indicative of a leak in the heat exchanger;
selecting, based on the variation of the pressure data, a leak testing technique from a set of leak testing techniques, each of the set of leak testing techniques defining an injection point for a fluorescent tracer and a detection target;
triggering a release the fluorescent tracer in the injection point;
receiving images comprising testing data of the detection target, the testing data comprising signals indicative of a location of the fluorescent tracer exiting through a rupture of the heat exchanger;
processing the images to identify a location of the rupture of the heat exchanger; and
generating a report comprising the location of the rupture of the heat exchanger.

2. The computer-implemented method of claim 1, wherein the variation of the pressure data comprises a decrease in the tube pressure and an identification of the shell pressure being substantially constant.

3. The computer-implemented method of claim 2, wherein the leak testing technique comprises a pinhole induced tube rupture detection.

4. The computer-implemented method of claim 1, wherein the variation of the pressure data comprises a decrease in the shell pressure and an identification of the tube pressure being substantially constant.

5. The computer-implemented method of claim 4, wherein the leak testing technique comprises a stationery tube to tube-sheet leak detection.

6. The computer-implemented method of claim 1, wherein the variation of the pressure data comprises a decrease in the shell pressure and an increase of the tube pressure.

7. The computer-implemented method of claim 6, wherein the leak testing technique comprises a floating tube to tube-sheet leak spotting using test ring.

8. The computer-implemented method of claim 1, wherein the variation of the pressure data comprises a decrease in the tube pressure and an increase of the shell pressure.

9. The computer-implemented method of claim 8, wherein the leak testing technique comprises a floating head gasket leak spotting.

10. A computer-implemented system comprising:
memory storing application programming interface (API) information; and
a server performing operations comprising:
receiving, from sensors attached to a heat exchanger, pressure data comprising tube pressure and shell pressure, the heat exchanger comprising tubes and a shell surrounding the tubes;
determining, by processing the pressure data, a variation of the pressure data indicative of a leak in the heat exchanger;
selecting, based on the variation of the pressure data, a leak testing technique from a set of leak testing techniques, each of the set of leak testing techniques defining an injection point for a fluorescent tracer and a detection target;
triggering a release the fluorescent tracer in the injection point;
receiving images comprising testing data of the detection target, the testing data comprising signals indicative of a location of the fluorescent tracer exiting through a rupture of the heat exchanger;
processing the images to identify a location of the rupture of the heat exchanger; and
generating a report comprising the location of the rupture of the heat exchanger.

11. The computer-implemented system of claim 10, wherein the variation of the pressure data comprises a decrease in the tube pressure and an identification of the shell pressure being substantially constant.

12. The computer-implemented system of claim 11, wherein the leak testing technique comprises a pinhole induced tube rupture detection.

13. The computer-implemented system of claim 10, wherein the variation of the pressure data comprises a decrease in the shell pressure and an identification of the tube pressure being substantially constant.

14. The computer-implemented system of claim 13, wherein the leak testing technique comprises a stationery tube to tube-sheet leak detection.

15. The computer-implemented system of claim 10, wherein the variation of the pressure data comprises a decrease in the shell pressure and an increase of the tube pressure.

16. The computer-implemented system of claim 15, wherein the leak testing technique comprises a floating tube to tube-sheet leak spotting using test ring.

17. The computer-implemented system of claim 10, wherein the variation of the pressure data comprises a decrease in the tube pressure and an increase of the shell pressure.

18. The computer-implemented system of claim 17, wherein the leak testing technique comprises a floating head gasket leak spotting.

19. A non-transitory computer-readable media encoded with a computer program, the computer program comprising instructions that when executed by one or more computers cause the one or more computers to perform operations comprising:
receiving, from sensors attached to a heat exchanger, pressure data comprising tube pressure and shell pressure, the heat exchanger comprising tubes and a shell surrounding the tubes;
determining, by processing the pressure data, a variation of the pressure data indicative of a leak in the heat exchanger;
selecting, based on the variation of the pressure data, a leak testing technique from a set of leak testing techniques, each of the set of leak testing techniques defining an injection point for a fluorescent tracer and a detection target;
triggering a release the fluorescent tracer in the injection point;
receiving images comprising testing data of the detection target, the testing data comprising signals indicative of a location of the fluorescent tracer exiting through a rupture of the heat exchanger;
processing the images to identify a location of the rupture of the heat exchanger; and
generating a report comprising the location of the rupture of the heat exchanger.

20. The non-transitory computer-readable media of claim 19, wherein the variation of the pressure data comprises a decrease in the tube pressure and an identification of the shell pressure being substantially constant, wherein the leak testing technique comprises a pinhole induced tube rupture detection or wherein the variation of the pressure data comprises a decrease in the shell pressure and an identification of the tube pressure being substantially constant, wherein the leak testing technique comprises a stationery tube to tube-sheet leak detection or wherein the variation of the pressure data comprises a decrease in the shell pressure and an increase of the tube pressure, wherein the leak testing technique comprises a floating tube to tube-sheet leak spotting using test ring or wherein the variation of the pressure data comprises a decrease in the tube pressure and an increase of the shell pressure, wherein the leak testing technique comprises a floating head gasket leak spotting.
